(19) United States
(12) Patent Application Publication
(10) Pub. No.: US 2018/0292079 A1
(43) Pub. Date: Oct. 11, 2018

(54) LIGHTED MIRROR WITH SOUND SYSTEM

(71) Applicants: Tony J. Branham, Gig Harbor, WA (US); David Xiao, Hangzhou (CN)

(72) Inventors: Tony J. Branham, Gig Harbor, WA (US); David Xiao, Hangzhou (CN)

(21) Appl. No.: 15/766,503

(22) PCT Filed: Oct. 7, 2016
(86) PCT No.: PCT/US16/56002

§ 371 Date: Apr. 6, 2018

Related U.S. Application Data
(60) Provisional application No. 62/238,584, filed on Oct. 7, 2015.

(51) Int. Cl. F21V 33/00; A47G 1/02; H04R 1/02; H04R 1/28; H04R 5/02

(52) U.S. Cl. CPC F21V 33/004; A47G 1/02; F21V 33/0056; F21Y 2115/10; H04R 1/028; H04R 1/2807; H04R 5/02; H04R 1/025

(57) ABSTRACT

A mirror system having a housing, a mirror mounted on the housing, a light system, a sound system mounted on or in the housing, the sound system including a wireless receiver and at least one speaker to output sound, a speaker enclosure for each speaker, the speaker enclosure including a speaker housing having a mounting surface suitable for mounting the at least one speaker in the interior of the speaker housing, an opening in the mounting surface that enables sound to pass from the front of the at least one speaker to outside the speaker housing, a series of sound baffles formed in the speaker housing that define a passageway having a first passage opening that communicates with the exterior of the speaker housing and a second passage opening that communicates with the back of the at least one speaker and provides fluid communication with the exterior of the speaker housing through the first passage opening.

### BACKGROUND OF THE DISCLOSURE

### Field of the Disclosure

The present disclosure pertains to mirrors and, more particularly, to a mirror that utilizes LED lighting and an on-board sound system wirelessly coupleable to a remote device, and having a speaker enclosure that cooperates with a wall to produce high quality sound.

### Description of the Related Art

Various designs for mirrors currently exist, many of which incorporate lights in the frame of the mirror. Studies have shown that most individuals prepare for the day while standing in front of a mirror. Many individuals desire to listen to the radio or pre-recorded music while preparing for the day.

Because most bathroom mirrors are not located near a power source, having a large wall mirror that is lighted with integral lighting has been problematic. Similarly, utilizing a plug-in radio or other source of music, news, talk shows, weather, traffic, and other voice communications in a bathroom setting is dangerous due to the close proximity of water and other chemicals that could damage the electronic equipment.

Hence, there is a need for a wall mount mirror in a bathroom setting that has built-in lighting and a sound system in which access to power is not an issue. In addition, there is a need for a relatively thin wall-mounted mirror that provides enhanced quality sound when mounted on a wall or other planar support structure.

### SUMMARY OF THE DISCLOSURE

The implementations of the present disclosure are directed to a mirror having one or more LED lights to illuminate the user and a sound system with a wireless receiver to couple electronically to a remote device that provides a connection to a source of music, entertainment, news, telephone, and other media and communication systems, including voice communications.

In accordance with another aspect of the present disclosure, a mirror system is provided that includes a housing, a mirror mounted on the housing, a plurality of LED lights mounted on the housing around an exterior of the mirror, a sound system mounted on or in the housing, the sound system including a wireless receiver and at least one speaker to output sound, a rechargeable source of power electrically coupled to the sound system and the plurality of LED lights, and a controller structured to control operation of the LED lights and the sound system.

### BRIEF DESCRIPTION OF THE DRAWING(S)

The features and advantages of the disclosed implementation of the disclosure will be more readily appreciated as the same become better understood from the following detailed description of a representative implementation when taken in conjunction with the accompanying drawings, wherein:

FIG. 1 is an isometric view of a wall-mounted mirror formed in accordance with one aspect of the present disclosure;

FIG. 2 is an isometric view of a rear exterior of the wall-mounted mirror of FIG. 1;

FIG. 3 is an isometric view of an interior of the wall-mounted mirror of FIG. 1; and

FIG. 4 is an enlarged isometric view the interior of the wall-mounted mirror of FIG. 3 showing additional details of the speaker enclosure.

### DETAILED DESCRIPTION OF THE DISCLOSURE

In the following description, certain specific details are set forth in order to provide a thorough understanding of various disclosed implementations. However, one skilled in the relevant scientific techniques will recognize that implementations may be practiced without one or more of these specific details, or with other methods, components, materials, etc. In other instances, well-known structures or components or both associated with mirrors, LED lights and related controls, wireless communication via Bluetooth technology, and remote broadcast systems have not been shown or described in order to avoid unnecessarily obscuring descriptions of the implementations.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one implementation” or “an implementation” means that a particular feature, structure, or characteristic described in connection with the implementation is included in at least one implementation. Thus, the appearance of the phrases “in one implementation” or “in an implementation” in various places throughout the specification are not necessarily all referring to the same implementation. Furthermore, the particular features, structures, or characteristics may be combined in any suitable manner in one or more implementations. For ease of reference, similar structures and features will be illustrated and described using the same reference number.

Generally, the present disclosure is directed to a household mirror that integrates lighting and a sound system configured to receive broadcast signals from a remote source, such as a Bluetooth linked cell phone or other personal device. The device can also include a microphone to permit remote voice communications.

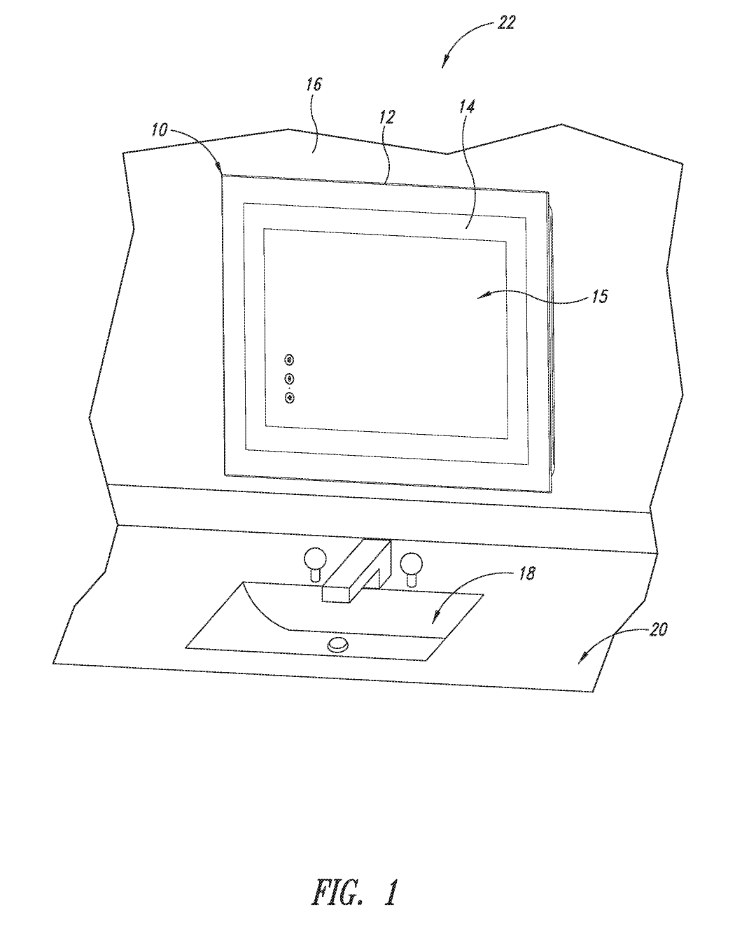

In accordance with a representative implementation of the disclosure, as shown in FIG. 1, a mirror assembly 10 is provided that includes a frame 12 with a circumscribing light 14, preferably formed of a string of LED lights located at least partially, and in this implementation completely, around a centrally positioned reflective mirror 15. The mirror assembly 10 of this implementation is designed for mounting to a wall 16, such as a wall 16 located behind a sink 18 associated with a counter 20. The wall 16 is typically formed of sheet rock or other common material used in the construction of residential and commercial buildings. The composition of the wall 16 is not critical to the proper functioning of the mirror assembly 10 or to the proper functioning of the system 22, which is composed of the mirror assembly 10 and the wall 16 as described more fully below.

The light 14 is structured to emit preferably a soft white light. Suitable controls (not shown) are provided for the light 14, which can be simply in the form of an on-off switch or a controller that enables variable adjustment in the amount of emitted light and, in some implementations, in the color emitted by one or more of the LED lights. Because the LED lights and control system are readily commercially available, they will not be described in detail herein. In one implementation, the light 12 covers about 120 square inches, and each LED light has a 6 W rating and is preferably structured to provide a warm white or soft white type of light. It is to be understood that other forms of lights may be used as are commonly known and readily commercially available, include incandescent lights and compact fluorescent lamps (CFL) as non-limiting examples.

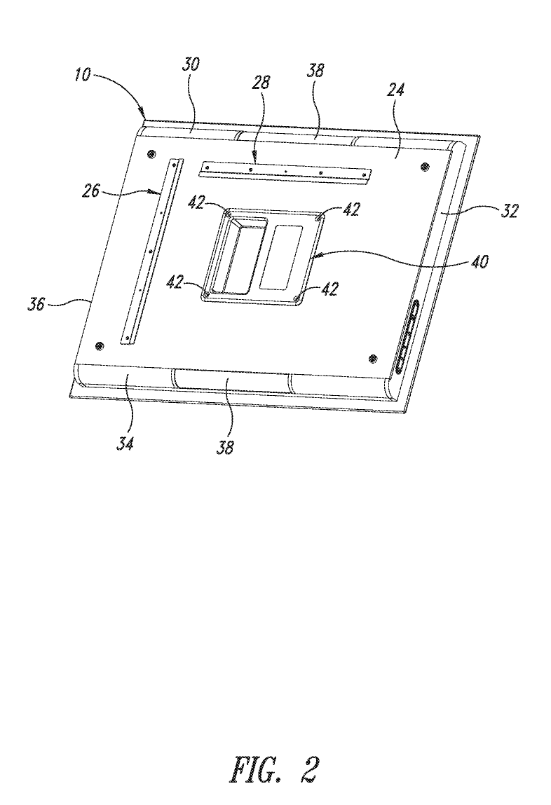

FIG. 2 illustrates the back wall 24 of the mirror assembly 10 of FIG. 1. Mounting brackets 26, 28 are mounted on the back wall 24 to facilitate hanging or attaching the mirror assembly 10 to the wall 16. Because such mounting systems are readily commercially available, they will not be described in detail herein. Ideally these brackets 26, 28 are positioned at 90 degrees to each other to allow a user to decide which direction the speaker ports described below should face. The mirror assembly 10 as shown has a rectangular shape, although other shapes may be used. It can be mounted in landscape or portrait orientation. Preferably the mirror assembly 10 attaches to the wall 16 or other planar support structure using a two-step wedge lock design, which is readily commercially available and will not be described in detail herein. Cushioned stabilizing pads help the mirror assembly 10 rest on the wall without causing or transferring vibrations. For best sound quality, the housing frame 12, back wall 24, and the front wall are constructed of wood. The inventors have found that bamboo for the back wall 24 provides the best quality of sound for this particular implementation.

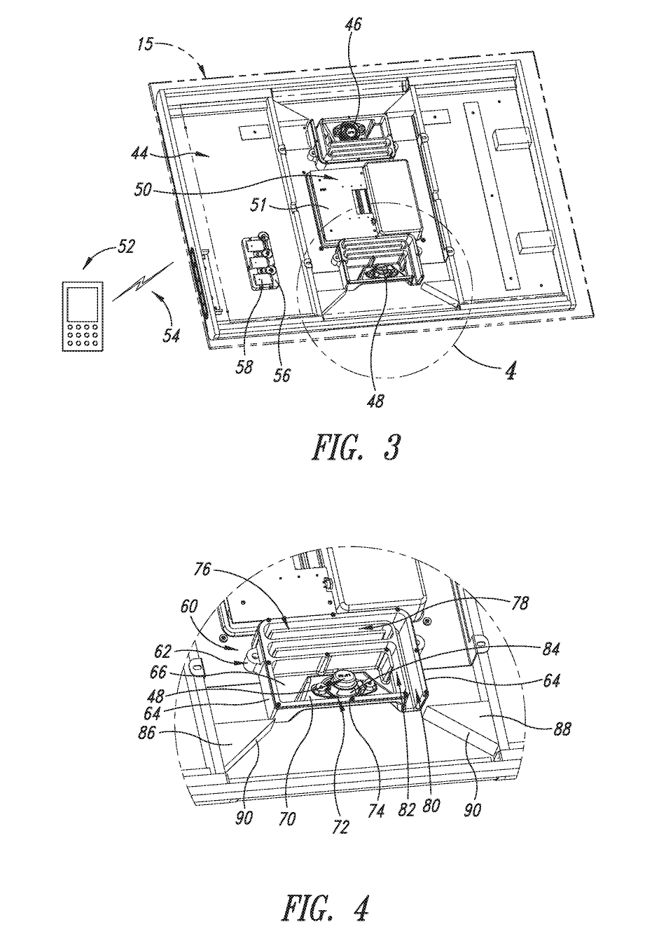

Four sidewalls 30, 32, 34, and 36 connect to the back wall 24 and are preferably formed of a multilayer board. In the opposing top and bottom side walls 30, 34 are formed speaker ports or sound openings 38 through which sound produced by internal speakers (described more fully below and illustrated in FIGS. 3 and 4) interacts with the wall 16 to produce enhanced quality sound as described more fully below. A repair cover 40 is centrally located in the back wall 24 and is removable to provide access to an interior of the mirror assembly. Fasteners, preferably screws 42, removably attach the repair cover 40 to the back wall 24.

The mirror assembly 10 also includes an internal sound system 44 shown in FIGS. 3 and 4. It is positioned behind the mirror 15, which for sake of clarity is shown in phantom lines. The sound system 40 includes a pair of stereo speakers 46, 48 integrally mounted within the mirror assembly 10, and a 2-channel quality sound system receiver and amplifier 50 electrically coupled to the speakers 46, 48. Preferably, the sound receiver and amplifier circuits are formed as part of a PCB assembly 51. Ideally, the sound system 44 provides 2-channel quality sound and outputs to 2×3 high quality speakers 46, 48. The system 44 uses 360 degree sound technology that utilizes wall acoustics for premium sound quality.

A remote source 52, shown in the form of a cell phone, is used to provide a signal 54 to a receiver in the sound system 44 in a conventional manner, such as with Bluetooth® wireless communications. The remote source 52 can be any type of wireless device, such as a radio, tablet, laptop computer, iPad® or other personal device that has Bluetooth connection capability and that can receive or provide music, news, voice communication, or other form of communication. Preferably the Bluetooth communication has a 30-foot range.

Also shown in FIG. 3 is an LSF Touch PCB frame 56 and an icon backed lighting board 58. Controls for the lights 12 and the sound system 16 are on-screen mounted to facilitate adjustment in the lighting and to provide Bluetooth fast pairing. An anti-fog system is also provided to reduce the build-up of moisture on a face of the mirror 14.

Shown more clearly in the enlarged illustration of FIG. 4, a speaker enclosure 60 is provided for each speaker 46, 48. The speaker enclosure 60 includes a speaker housing 62 having side walls 64 and a bottom wall 66. There is no top wall because the back wall 24 of the mirror assembly 10 serves as the back wall of the housing 62 in this implementation. The speaker housing 62 includes a mounting surface 70 suitable for mounting the speaker 48 in the interior of the speaker housing 62, an opening 72 in the mounting surface 70 that enables sound to pass from the front 74 of the speaker 48 to outside the speaker housing 62. A series of sound baffles 76 formed in the speaker housing 62 define a passageway 78 having a first passage opening 80 that communicates with the exterior of the speaker housing 62 and a second passage opening 82 that communicates with the back 84 of the speaker 48 and provides fluid communication with the exterior of the speaker housing 62 through the first passage opening 80.

Ideally the passageway 78 is in the form of a serpentine arrangement. The second passage opening 84 faces outward from the speaker housing 62 in a first direction and the speaker opening 72 in the mounting surface 70 for the speaker 48 faces in a second direction that is different than the first direction, and preferably in an opposite direction.

In a preferred implementation, the mounting surface 70 is angled with respect to the bottom wall 66 of the speaker housing 62, preferably at an acute angle as measured between the bottom wall 66 and the mounting surface, to enable sound to pass through the speaker opening 72 and away from the speaker housing 62. This is a unique process to project sound to the sides (or top and bottom, depending on orientation of the mirror assembly 10 on the wall) while staying very slim. The mirror assembly 10 sits just 1.5 inches off the wall 16 and the speakers project sound at an angle that flares wider like a cone and also into the wall. The sound casts to the wall for best sound quality.

The mirror assembly 10 also includes first and second blocks 86, 88 mounted on each side of the speaker housing 62 adjacent the angled mounting surface 70 to direct sound from the speaker 48 in a cone shape away from the speaker housing 62. Ideally each block 86, 88 has a right triangular shape with the hypotenuse 90 forming a side of the cone.

The mirror assembly 10 sidewall 32 extends around the mirror housing, and the sidewall 32 includes the sound opening 38 for each respective speaker 46, 48 to enable sound to pass from the speaker 46, 48, through the sound opening 38.

While the mirror assembly 10 can be designed to utilize power from a wall receptacle through a standard wire and plug connection, preferably 12V DC input to the mirror electronics, power is provided by an on-board Lithium rechargeable battery. Ideally the electronics utilize 12V, 2 amp power. The battery ideally is a 2600 mA/h rapid charge li-on battery. This provides 8 hours of continuous play for the sound system and 7 hours of lighting time for the LED lights 12. Recharging is facilitated by smart balance charging management.

From the foregoing it will be appreciated that, although specific implementations of the disclosure have been described herein for purposes of illustration, various modifications may be made without deviating from the spirit and scope of the disclosure. For example, an auxiliary jack can be included for the sound system to provide direct wire connection to the sound source. Accordingly, the disclosure is not limited except as by the appended claims and the equivalents thereof.

U.S. Provisional Patent Application No. 62/238,584, filed on Oct. 7, 2015, is incorporated herein by reference in its entirety.

1. A mirror assembly, comprising:
a mirror housing having a front and a rear;
a mirror mounted on the mirror housing;
a light system mounted on the mirror housing and located at least partially around an exterior perimeter of the mirror;
a sound system mounted on or in the mirror housing, the sound system including a wireless receiver and at least one speaker to output sound, the at least one speaker having a front and a back;
a source of power electrically coupled to the sound system and the light system; and
a controller structured to control operation of the light system and the sound system; and
a speaker enclosure for each at least one speaker, the speaker enclosure including:
a speaker housing having a mounting surface suitable for mounting the at least one speaker in an interior of the speaker housing;
an opening in the mounting surface that enables sound to pass from the front of the at least one speaker to a rear of the speaking housing and to an exterior of the speaker housing;
a plurality of sound baffles forming a serpentine arrangement in the speaker housing to define a sound passageway, the sound passageway including:
a first passage opening that communicates with the exterior of the speaker housing; and
a second passage opening that communicates with the back of the at least one speaker.

2. (canceled)

3. (canceled)

4. The mirror assembly of claim 1 wherein the at least one speaker comprises first and second speakers and the speaker housing comprises first and second speaker housings for the respective first and second speakers, and the opening in the mounting surface of the first speaker housing faces in an opposite direction than the opening in the mounting surface of the second speaker housing.

5. The mirror assembly of claim 4, wherein the mounting surface in each of the first and second housings is angled with respect to a bottom wall of the speaker housing to enable sound to pass through the opening in the mounting surface and away from the speaker housing.

6. The mirror assembly of claim 5, comprising first and second blocks mounted on each side of the speaker housing adjacent the angled mounting surface to direct sound from the speaker in a cone away from the speaker housing.

7. The mirror assembly of claim 6, wherein the mirror assembly comprises a sidewall extending around the mirror housing, and the sidewall includes a sound opening for each respective speaker to enable sound to pass from the speaker, through the sound opening.

8. A system, comprising:
a wall; and
a mirror assembly mounted on the wall, the mirror assembly comprising:
a mirror housing having a front and a rear;
a mirror mounted on the mirror housing;
a light system mounted on the mirror housing and located at least partially around an exterior perimeter of the mirror;
a sound system mounted on or in the mirror housing, the sound system including a wireless receiver and at least one speaker to output sound, the at least one speaker having a front and a back;
a source of power electrically coupled to the sound system and the light system; and
a controller structured to control operation of the light system and the sound system; and
a speaker enclosure for each at least one speaker, the speaker enclosure including a speaker housing having a mounting surface suitable for mounting the at least one speaker in an interior of the speaker housing, an opening in the mounting surface that enables sound to pass from the front of the at least one speaker to outside the speaker housing and to the rear of the mirror housing, a series of sound baffles formed in the speaker housing that define a serpentine passageway having a first passage opening that communicates with the exterior of the speaker housing and the rear of the mirror housing and a second passage opening that communicates with the back of the at least one speaker and the rear of the mirror housing.

9. (canceled)

10. (canceled)

11. The system of claim 10 wherein the at least one speaker comprises first and second speakers and the speaker housing comprises first and second speaker housings for the respective first and second speakers, and the opening in the mounting surface of the first speaker housing faces in an opposite direction than the opening in the mounting surface of the second speaker housing.

12. The system of claim 11, wherein the mounting surface in each of the first and second housings is angled with respect to a bottom wall of the speaker housing to enable sound to pass through the opening in the mounting surface and away from the speaker housing.

13. The system of claim 12, comprising first and second blocks mounted on each side of the speaker housing adjacent the angled mounting surface to direct sound from the speaker in a cone away from the speaker housing.

14. The system of claim 13, wherein the mirror assembly comprises a sidewall extending around the mirror housing, and the sidewall includes a sound opening for each respective speaker to enable sound to pass from the speaker, through the sound opening.
